(19) United States
(12) Patent Application Publication
(10) Pub. No.: US 2026/0303940 A1
(43) Pub. Date: Oct. 1, 2026

(54) OPTICAL APPARATUS

(71) Applicant: CANON KABUSHIKI KAISHA, Tokyo (JP)

(72) Inventor: MITSURU MOROHASHI, Tokyo (JP)

(21) Appl. No.: 19/550,984

(22) Filed: Feb. 26, 2026

(30) Foreign Application Priority Data
Mar. 26, 2025 (JP) 2025-051747
Sep. 5, 2025 (JP) 2025-147385

(51) Int. Cl. H04N 23/55; G02B 7/09; H04N 23/69

(52) U.S. Cl. CPC H04N 23/55; G02B 7/09; H04N 23/69

(57) ABSTRACT

An optical apparatus includes an operation member that can operate an optical member, and has a first operation region and a second operation region along a circumferential direction of the operation member, one or more memories storing instructions, and one or more processors that, upon execution of the instructions, operate to control the optical member, according to a rotational operation of the operation member in the circumferential direction, in a control mode selected from a plurality of modes including a first mode and a second mode, control the optical member in the first mode according to the rotational operation in the first operation region of the operation member, and control the optical member in the second mode according to the rotational operation in the second operation region of the operation member.

### BACKGROUND

### Field of the Technology

The present disclosure relates to an optical apparatus.

### Description of the Related Art

Japanese Patent Application Laid-Open No. 3-233419 discloses a motor-driven zoom lens barrel in which, in order to reduce an overall length, a single zoom operation ring is slid in an optical axis direction to selectively connect a switch ring and a manual zoom ring, thereby enabling switching between manual zoom operation and motor-driven zoom operation.

### SUMMARY

An optical apparatus according to one aspect of the present disclosure may include an operation member that can operate an optical member, and has a first operation region and a second operation region along a circumferential direction of the operation member, one or more memories storing instructions, and one or more processors that, upon execution of the instructions, operate to control the optical member, according to a rotational operation of the operation member in the circumferential direction, in a control mode selected from a plurality of modes including a first mode and a second mode, control the optical member in the first mode according to the rotational operation in the first operation region of the operation member, and control the optical member in the second mode according to the rotational operation in the second operation region of the operation member.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of an imaging system according to a first embodiment.

FIGS. 2A and 2B illustrate indices of a zoom operation ring according to the first embodiment.

FIGS. 3A and 3B illustrate a non-operated state and an operated state of a switching operation unit according to the first embodiment.

FIG. 4 is a block diagram of the imaging system according to the first embodiment.

FIG. 5 is a sectional view of the imaging system (in a wide-angle (WIDE) state or at a wide-angle end) according to the first embodiment.

FIG. 6 is a sectional view of the imaging system (in a telephoto (TELE) state or at a telephoto end) according to the first embodiment.

FIGS. 7A and 7B are sectional views of a zoom operation ring unit according to the first embodiment.

FIG. 8A is an exploded perspective view of the zoom operation ring unit according to the first embodiment.

FIG. 8B is an exploded perspective view of the zoom operation ring unit according to the first embodiment.

FIG. 8C is a detailed view of the zoom operation ring unit according to the first embodiment.

FIG. 8D is a detailed view of the zoom operation ring unit according to the first embodiment.

FIG. 9A and 9B are perspective views of a switching member according to the first embodiment.

FIGS. 10A to 10M illustrate an internal state of the zoom operation ring unit according to the first embodiment.

FIG. 11A and 11B illustrate an index of a focus operation ring according to a second embodiment.

FIG. 12A and 12B illustrate an index of an iris operation ring according to a third embodiment.

FIGS. 13A to 13C are exploded perspective views of a zoom operation ring unit according to a fourth embodiment.

FIGS. 14A to 14E illustrate an internal state of the zoom operation ring unit according to the fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Hereinafter, embodiments of the present disclosure will be described in detail with reference to the drawings. Throughout the drawings, the same reference numerals denote the same or corresponding parts. The present embodiment will discuss an interchangeable lens as an example of an optical apparatus. However, the present disclosure is not limited to this example, and various modifications and changes may be made within the gist of the present disclosure, such as application to a lens-integrated camera.

### FIRST EMBODIMENT

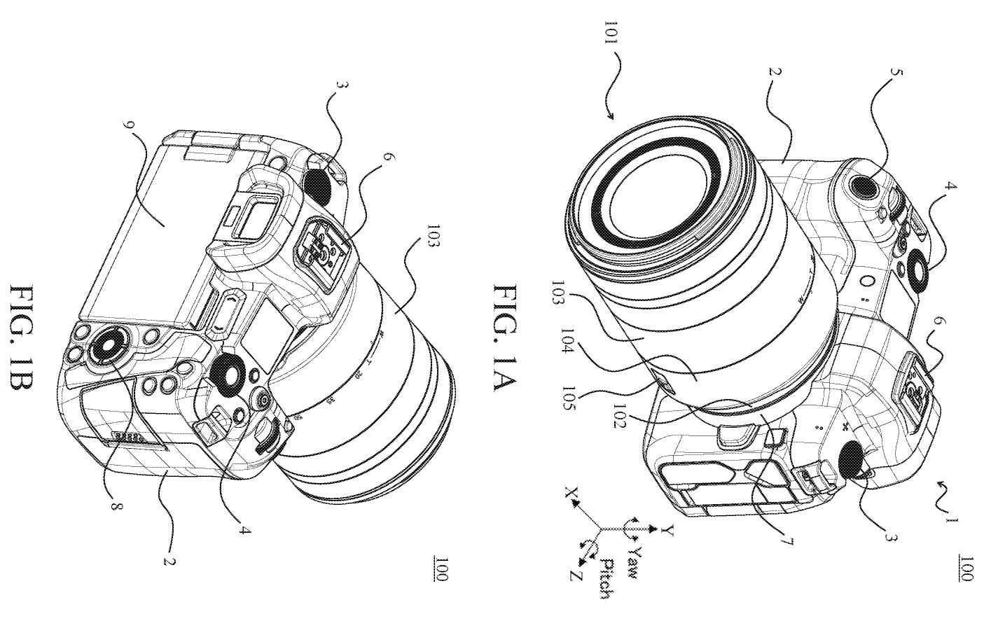

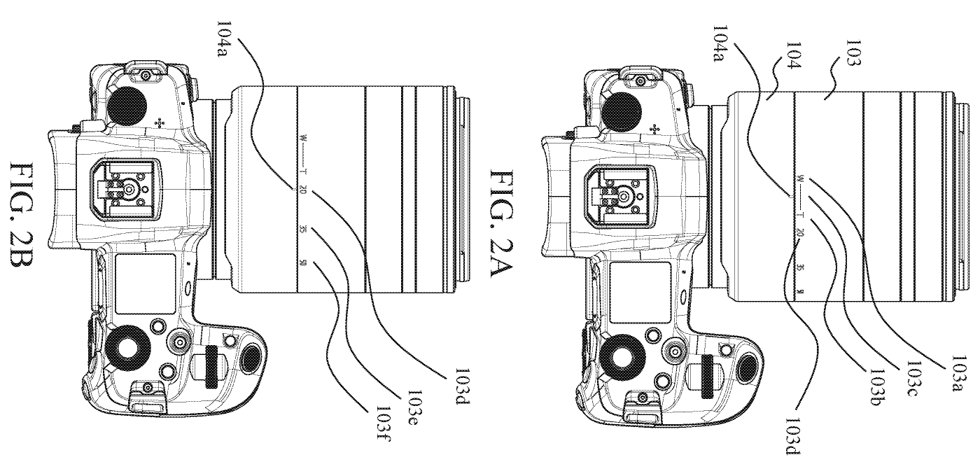

FIGS. 1A and 1B are external views of an imaging system (camera system) 100 according to a first embodiment of the present embodiment. FIG. 1A is a perspective view viewed from a front side, and FIG. 1B is a perspective view viewed from a rear side. The imaging system 100 consists of a camera body (image pickup apparatus) 1 and a lens apparatus (interchangeable lens, optical apparatus) 101 that is detachably attached to the camera body 1. The present embodiment is not limited to this example, and is also applicable to an image pickup apparatus in which the camera body and the lens apparatus are integrated.

As illustrated in FIG. 1A, an optical axis direction in which an optical axis of an imaging optical system accommodated in the lens apparatus 101 extends is defined as an X-axis direction. Directions orthogonal to the X-axis direction are defined as a Z-axis direction (horizontal direction) and a Y-axis direction (vertical direction). Hereinafter, the Z-axis direction and the Y-axis direction are also collectively referred to as a Z/Y-axis direction. A rotation direction about the Z-axis is defined as a pitch direction, and a rotation direction about the Y-axis is defined as a yaw direction. The pitch direction and the yaw direction are rotation directions about two axes, the Z-axis and the Y-axis, which are orthogonal to each other.

A grip portion 2 for a user to hold the camera body 1 by hand is provided on a portion of the camera body 1 that is on a left side when viewed from the front or object side (a right side when viewed from the rear). A power operation unit 3 is disposed on an upper surface of the camera body 1. When the user operates the power operation unit 3 to a power-on position while the camera body 1 is in a power-off state, the camera body 1 enters a power-on state and imaging (shooting or capturing an image) becomes available. When the user operates the power operation unit 3 to a power-off position while the camera body 1 is in a power-on state, the camera body 1 enters a power-off state.

A mode dial 4, a release button 5, and an accessory shoe 6 are provided on the upper surface of the camera body 1. By rotating the mode dial 4, the user can switch an imaging mode. The imaging mode includes a manual still image capturing mode in which the user can arbitrarily set an imaging mode such as a shutter speed and an aperture value (F-number), an automatic still image capturing mode for automatically obtaining a proper exposure amount, and a moving image capturing mode for capturing a moving image. By half-pressing the release button 5, the user can instruct an imaging preparation operation such as autofocus (AF) and auto-exposure (AE) control, and by fully pressing the release button 5, the user can instruct imaging. An accessory such as an external flash or an external viewfinder (EVF), not illustrated, is detachably attached to the accessory shoe 6. An image sensor that photoelectrically converts an object image formed by the imaging optical system in the lens apparatus 101 is provided inside the camera body 1.

The lens apparatus 101 is mechanically and electrically connected to a camera mount 7 provided on the camera body 1 via a lens mount 102. As described above, the lens apparatus 101 accommodates the imaging optical system that forms an object image by imaging light from an object. A zoom operation ring (zoom operation member) 103 that is rotatable about the optical axis by user operation is provided on an outer circumference of the lens apparatus 101. A knurled shape is formed on an outer circumference portion of the zoom operation ring 103 so that a user’s hand does not slip during operation. When the zoom operation ring 103 is rotated by the user, the zoom unit constituting the imaging optical system moves the optical position in accordance with the operation of the zoom operation ring 103. Details of the zoom operation will be described later. By operating the zoom operation ring, the user can perform imaging at a desired angle of view.

A switching operation unit 105 that is slidable in the optical axis direction by a user operation is also provided on the outer circumference of the lens apparatus 101. Details of the operation of the switching operation unit 105 will be described later. By using the switching operation unit 105 and the zoom operation ring 103, the user can switch between a power zoom (PZ) operation (first method, first mode) and a manual zoom (MZ) operation (second method, second mode). In accordance with the switching operation performed by the user, a lens control unit (control unit) 106 can switch a control method for an optical member (such as a zoom lens) selected from a plurality of methods including the first method and the second method.

As illustrated in FIG. 1B, a rear operation unit 8 and a display unit 9 are provided on a rear surface of the camera body 1. The rear operation unit 8 includes a plurality of buttons and dials to which various functions are assigned. When the camera body 1 is in a power-on state and a still or moving imaging mode is set, the display unit 9 displays a through-image of the object image captured by the image sensor. The display unit 9 also displays an imaging parameter indicating an imaging condition such as a shutter speed and an aperture value. The user can change a setting value of the imaging parameter by operating the rear operation unit 8 while viewing the display. The rear operation unit 8 includes a playback button for instructing playback of recorded captured images. When the user operates the playback button, the captured image is played back and displayed on the display unit 9.

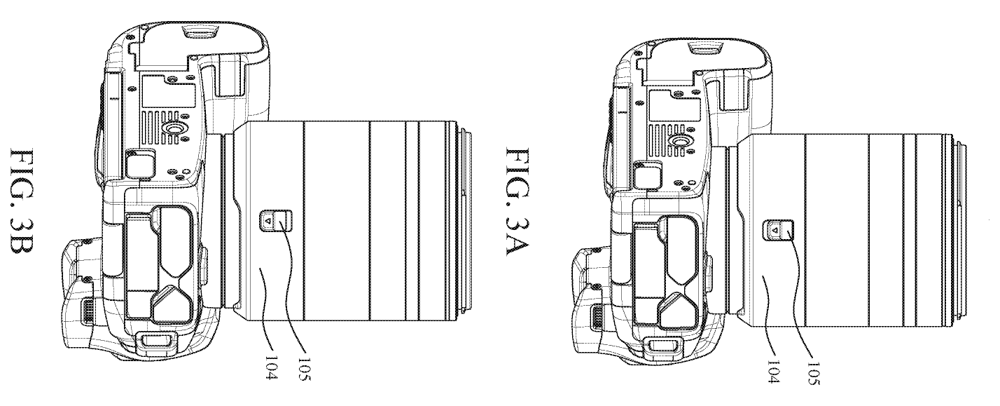

FIGS. 2A and 2B illustrate indicators of the zoom operation ring 103 according to the present embodiment. FIG. 2A illustrates a PZ operation focus indicator disposed in a first operation region. FIG. 2B illustrates an MZ operation focus indicator disposed in a second operation region. The PZ operation is an operation for changing a focal length toward a wide-angle (WIDE) direction or a telephoto (TELE) direction (for zooming) by moving the zoom operation ring 103 in the WIDE or TELE direction indicated on the zoom operation ring 103. The zoom operation ring 103 has a neutral position (reference position) in the first operation region, at which the focal length does not change during the PZ operation (the zoom lens is not moved). The MZ operation is an operation for changing the focal length to a desired focal length by aligning a focal-length scale indicated on the zoom operation ring 103 with a zoom indicator line 104a of an exterior ring (fixed member) 104 of the lens apparatus 101.

Thus, the zoom operation ring 103 has the first operation region and the second operation region along a circumferential direction (rotation operation direction, about the optical axis). The lens control unit 106 controls the zoom lens by the PZ operation (first method) in accordance with a rotation operation of the zoom operation ring 103 in the first operation region. The lens control unit 106 also controls the zoom lens by the MZ operation (second method) in accordance with a rotation operation of the zoom operation ring 103 in the second operation region. During the PZ operation, the lens control unit 106 performs relative position control on the zoom lens in accordance with the operation of the zoom operation ring 103, and drives the zoom lens in a direction corresponding to the operation from a current position. During the MZ operation, the lens control unit 106 performs absolute position control on the zoom lens in accordance with the operation of the zoom operation ring 103 (drives the zoom lens to a target position corresponding to the operation).

As illustrated in FIG. 2A, “W” is displayed as a PZ WIDE direction indicator 103a. “T” is displayed as a PZ TELE direction indicator 103b. The PZ WIDE direction indicator 103a and the PZ TELE direction indicator 103b are disposed in the first operation region. A PZ neutral position (reference position) 103c is displayed between the direction indicators 103a and 103b. By using these indicators, the user can instruct the lens apparatus 101 to change the focal length relatively toward the WIDE direction or the TELE direction (relative position control). The user can also instruct the stopping of the movement of the zoom lens (optical member) by using the PZ neutral position 103c.

As illustrated in FIG. 2B, an MZ WIDE focus indicator 103d, an MZ MIDDLE focus indicator 103e, and an MZ TELE focus indicator 103f are displayed. The MZ WIDE focus indicator 103d, the MZ MIDDLE focus indicator 103e, and the MZ TELE focus indicator 103f are disposed in the second operation region. By using these indicators, the user can instruct the lens apparatus 101 to change the focal length as an absolute value (absolute position control).

During the PZ operation, the user can feel a first end at which rotation is restricted at the position of the PZ WIDE direction indicator 103a, and a second end at which rotation is restricted at the position of the PZ TELE direction indicator 103b. During the PZ operation, a neutral-position return force that biases the zoom operation ring 103 to return to the neutral position 103c acts on the zoom operation ring 103. Thereby, while the user releases the zoom operation ring 103 and no operating force is applied to the zoom operation ring 103, the zoom operation ring 103 moves to the neutral position 103c.

During the MZ operation, the user can feel a third end at which rotation is restricted at the position of the MZ WIDE focus indicator 103d, and a fourth end at which rotation is restricted at the position of the MZ TELE focus indicator 103f. Thereby, the user can sense the WIDE or TELE focus indicator by the tactile feeling of the ends without visually checking the indicator, and perform imaging.

FIGS. 3A and 3B illustrate the switching operation unit 105 according to the present embodiment. FIG. 3A illustrates a non-operated state, and FIG. 3B illustrates an operated state. As illustrated in FIGS. 3A and 3B, the switching operation unit 105 is provided on an outer circumference of the exterior ring (fixed member) 104 of the lens apparatus 101. In a non-operated state in which the user does not operate the switching operation unit 105, the switching operation unit 105 is biased toward the object side (upward in FIG. 3A). In the non-operated state, the lens apparatus 101 is configured such that the user can feel the first end and the second end, or the third end and the fourth end, and is configured to restrict switching (transition) between the first operation region and the second operation region.

In a case where the user intends to switch from the PZ operation to the MZ operation, or from the MZ operation to the PZ operation, the user pulls the switching operation unit 105 toward the image-plane side (downward in FIG. 3B), as illustrated in FIG. 3B. Thereby, the second end or the third end that separates the first operation region and the second operation region can be retracted. The second end or the third end also serves as a region-dividing end that divides the first operation region and the second operation region. Thus, the user can move between (switch between) the PZ operation region, which is the first operation region, and the MZ operation region, which is the second operation region.

Thus, the zoom operation ring 103 has a plurality of ends that restrict rotation in a circumferential direction during a rotation operation. The plurality of ends may include a first end, a second end, a third end, and a fourth end. The zoom operation ring 103 may have the first end and the second end in the first operation region. The zoom operation ring 103 may have the third end and the fourth end in the second operation region. A rotation member 311 described later may have an end portion that comes into contact with at least one of the first end and the second end of the zoom operation ring 103.

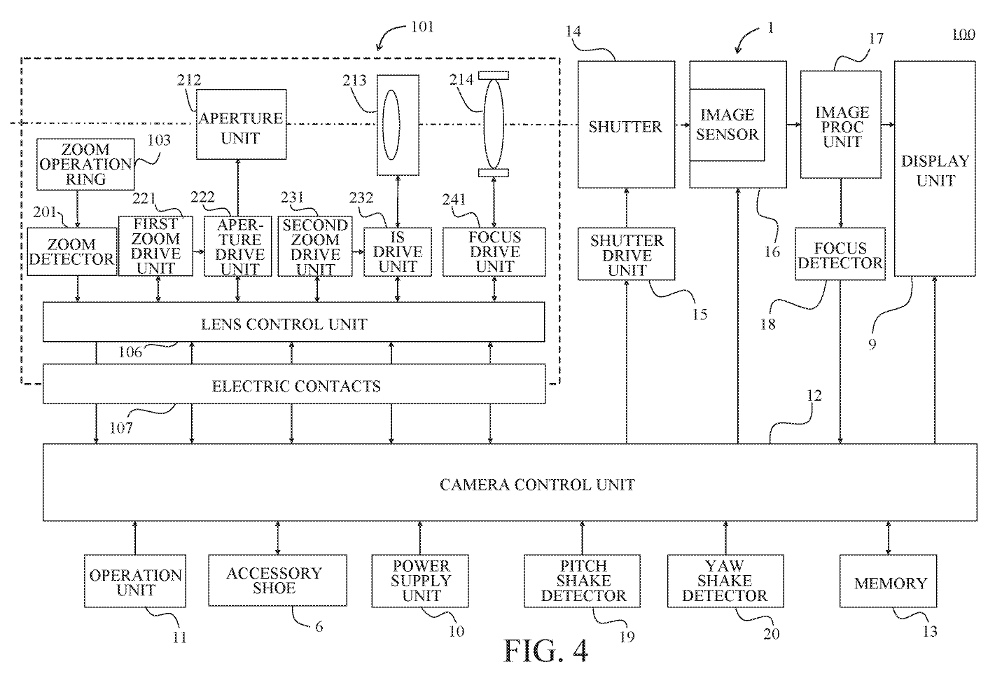

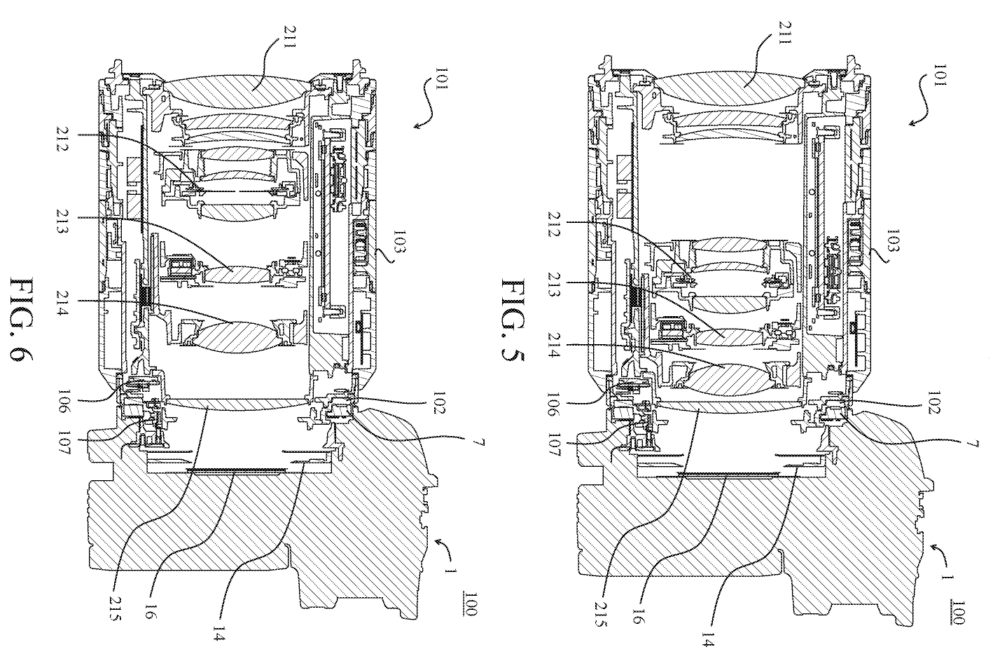

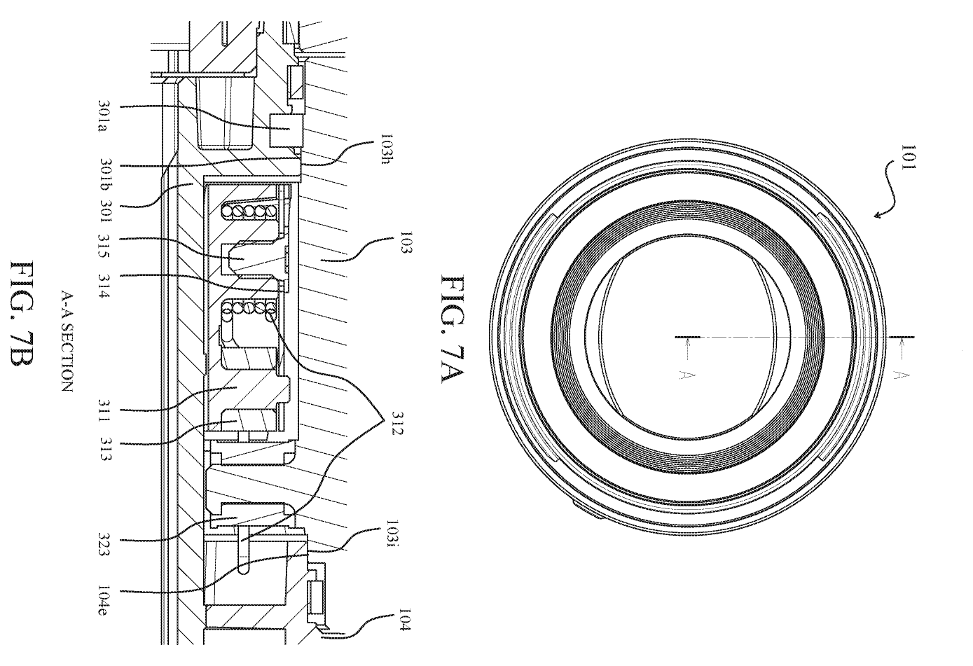

FIG. 4 is a block diagram illustrating the electrical and optical configurations of the imaging system 100 consisting of the lens apparatus 101 and the camera body 1. The camera body 1 has a power supply unit 10 that supplies power to the camera body 1 and the lens apparatus 101, and an operation unit 11 including the power operation unit 3, the mode dial 4, the release button 5, the rear operation unit 8, and a touch panel function of the display unit 9. Control of the entire system including the camera body 1 and the lens apparatus 101 is performed by cooperation between a camera control unit 12 provided in the camera body 1 and a lens control unit 106 provided in the lens apparatus 101. The camera control unit 12 reads and executes a computer program stored in a memory 13. At that time, the camera control unit 12 communicates a variety of control signals and data with the lens control unit 106 via communication terminals of electrical contacts 107 provided on the lens mount 102. The electrical contacts 107 include power terminals that supply power from the power supply unit 10 to the lens apparatus 101.

The imaging optical system in the lens apparatus 101 includes a first zoom unit (zoom lens, optical member) 212 and a second zoom unit 213 that move in the optical axis direction to change an angle of view. The first zoom unit 212 includes an aperture unit (aperture stop, diaphragm) that performs a light-amount adjusting operation. The second zoom unit 213 is also an image stabilizing unit that includes a shift lens as an image stabilizing element for reducing image blur. The image stabilizing unit 213 performs an image stabilizing operation by moving (shifting) the shift lens in the Z/Y-axis direction orthogonal to the optical axis to reduce image blur. A focus unit 214 includes a focus lens (optical member) that moves in the optical axis direction to perform focusing.

The lens apparatus 101 further includes an aperture drive unit 222 that drives the aperture unit of the first zoom unit 212, an image-stabilization (IS) drive unit 232 that drives the image stabilizing unit 213 to shift the shift lens, and a focus drive unit 241 that drives the focus unit 214 to move the focus lens. The lens apparatus 101 further includes a first zoom drive unit 221 that moves the first zoom unit 212 in the optical axis direction, and a second zoom drive unit 231 that moves the image stabilizing unit 213 in the optical axis direction.

The camera body 1 includes a shutter unit 14, a shutter drive unit 15, an image sensor 16, an image processing unit 17, and the camera control unit 12 described above. The shutter unit 14 controls an amount of light that is condensed by the imaging optical system in the lens apparatus 101 and exposed on the image sensor 16. The image sensor 16 photoelectrically converts an object image formed by the imaging optical system and outputs an imaging signal. The image processing unit 17 performs a variety of image processing operations on the imaging signal and then generates an image signal. The display unit 9 displays the image signal (through-image or live-view image) output from the image processing unit 17, displays an imaging parameter as described above, or plays back and displays a captured image recorded in the memory 13 or an unillustrated recording medium.

The camera control unit 12 controls the driving of the first zoom unit (aperture unit) 212 and the shutter unit 14 via the aperture drive unit 222 and the shutter drive unit 15 in accordance with set values of the aperture value and shutter speed received from the operation unit 11. The aperture unit has an aperture member including a plurality of aperture blade members for forming an arbitrary aperture diameter and an aperture rotation member that rotates about the optical axis center and causes the aperture blade members to follow. By interlocking the aperture drive unit 222 and the aperture rotation member, an arbitrary aperture diameter is formed to control a light amount.

The camera control unit 12 controls driving of the focus unit 214 in accordance with an imaging preparation operation (half-press operation) of the release button 5 of the operation unit 11. For example, in a case where an autofocus operation is instructed, a focus detector 18 determines a focus state of an object image formed on the image sensor 16 based on an image signal generated by the image processing unit 17, generates a focus signal, and transmits the focus signal to the camera control unit 12. At the same time, the focus drive unit 241 detects a current position of the focus unit 214 and transmits the signal to the camera control unit 12 via the lens control unit 106. The camera control unit 12 compares the focus state of the object image with the current position of the focus unit 214, calculates a focus drive amount from a shift amount, and transmits the focus drive amount to the lens control unit 106. The lens control unit 106 then controls driving of the focus unit 214 via the focus drive unit 241 to a target position, thereby correcting a focus shift of the object image.

In a case where an auto-exposure control operation is instructed, the camera control unit 12 receives a luminance signal generated by the image processing unit 17 and performs photometric calculation (or light metering calculation). Based on a result of the photometric calculation, the camera control unit 12 controls driving of the first zoom unit (aperture unit) 212 according to an imaging instruction operation (full-press operation) of the operation unit 11 (the release button 5). The camera control unit 12 also controls driving of the shutter unit 14 via the shutter drive unit 15 and performs exposure processing by the image sensor 16.

The camera body 1 includes a pitch shake detector 19 and a yaw shake detector 20 as shake detectors capable of detecting image blur such as camera shake caused by a user. The pitch shake detector 19 and the yaw shake detector 20 detect image blur in a pitch direction (a rotation direction about the Z-axis) and a yaw direction (a rotation direction about the Y-axis) using an angular velocity sensor (vibration gyro) or an angular acceleration sensor, and output a shake signal. The camera control unit 12 calculates a shift position of the image stabilizing unit 213 (shift lens) in the Y-axis direction using the shake signal from the pitch shake detector 19. Similarly, the camera control unit 12 calculates a shift position of the image stabilizing unit 213 in the Z-axis direction using the shake signal from the yaw shake detector 20. Then, the camera control unit 12 drives and controls the image stabilizing unit 213 to a target position according to the calculated shift positions in the pitch/yaw directions, and performs an image stabilizing operation to reduce image blur during exposure or through-image display.

The lens apparatus 101 includes the zoom operation ring 103 for changing an angle of view of an imaging optical system, and a zoom detector 201 that detects an angle (position) of the zoom operation ring 103. The zoom detector 201 detects the angle of the zoom operation ring 103 operable by the user as an absolute value, and is configured using, for example, a resistive arcuate sensor. Information on the angle of view detected by the zoom detector 201 is transmitted to the lens control unit 106 and reflected in various controls by the camera control unit 12 described above. Some of various types of information are recorded together with captured images in the memory 13 or a recording medium.

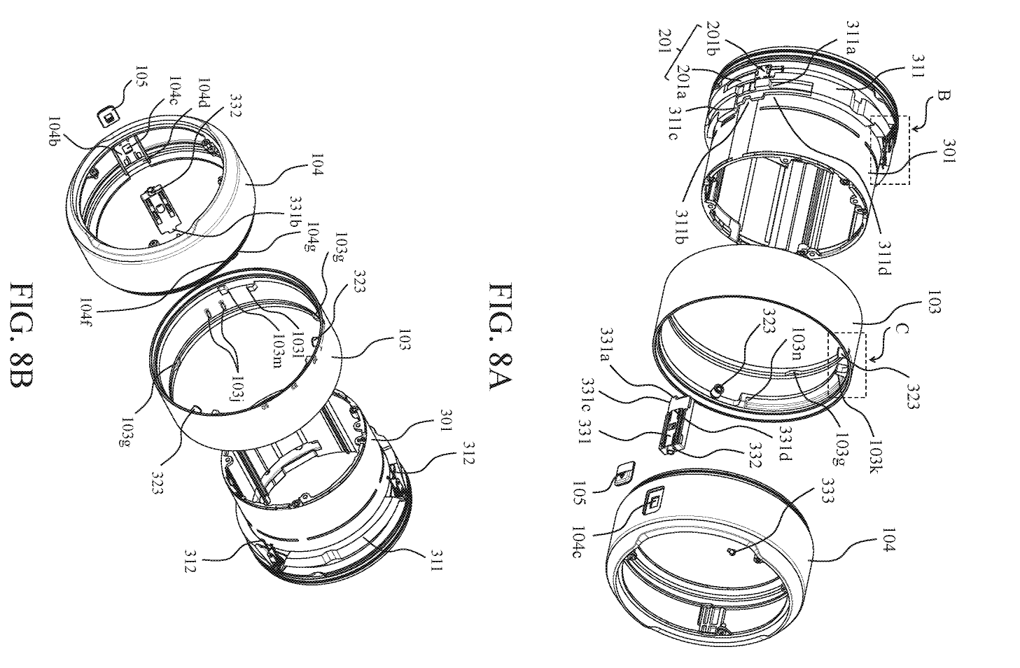

Referring now to FIGS. 5 and 6, a description will be given of a positional relationship among components in the lens apparatus 101 and the camera body 1 will be described. FIGS. 5 and 6 are sectional views of the imaging system 100 on the XY plane including the optical axis, where FIG. 5 illustrates a wide-angle state and FIG. 6 illustrates a telephoto state. A centerline illustrated here substantially coincides with the optical axis defined by the imaging optical system, and thus is regarded as the optical axis below.

The present embodiment adopts a five-unit configuration as an example of the imaging optical system. Each zoom unit moved to a predetermined optical position according to the angle of view forms an object image on an imaging surface of the image sensor 16. At this time, an aperture unit functions as a first zoom unit 212, and an image stabilizing unit functions as a second zoom unit 213. The imaging optical system includes a first unit 211 that is a fixed unit, a second unit that is an aperture unit 212, a third unit that is an image stabilizing unit 213, a fourth unit 214 as a focus unit, and a fifth unit 215 that is a fixed unit. The present embodiment is not limited to this configuration. For example, the fifth unit 215 may be configured to function as the third zoom unit. Some lens units may be fixed instead of being movable.

When the user rotates the zoom operation ring 103, the lens control unit 106 drives and controls the second unit (aperture unit, optical member) 212 to a target position via the first zoom drive unit 221 based on the angle-of-view information detected by the zoom detector 201, thereby moving it forward and backward in the optical axis direction. The lens control unit 106 also drives and controls the third unit (image stabilizing unit) 213 to a target position via the second zoom drive unit 231, thereby moving it forward and backward in the optical axis direction. Thereby, the user may capture an image with a desired angle of view.

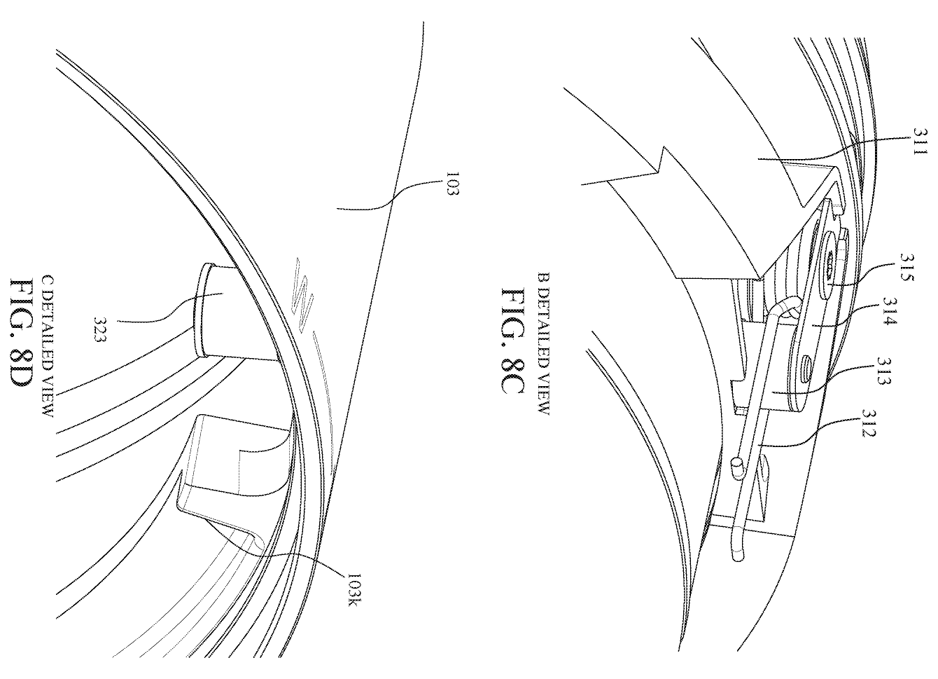

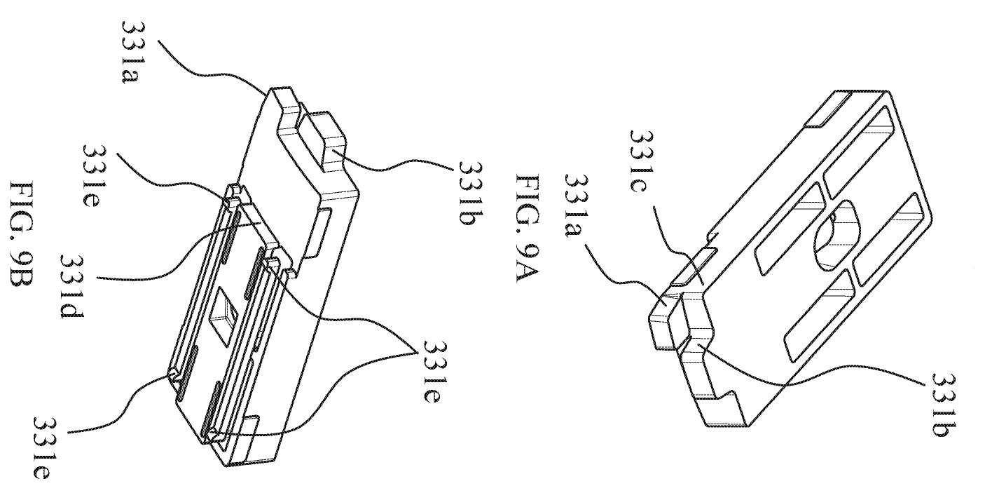

FIGS. 7A and 7B are configuration diagrams of a zoom operation ring unit according to the present embodiment. FIG. 7A is a sectional view viewed from the optical axis direction, and FIG. 7B is a sectional view taken along a line A-A in FIG. 7A. Reference numeral 103 denotes a zoom operation ring (operation member). Reference numeral 104 denotes an exterior ring (fixed member). Reference numeral 301 denotes a fixed barrel (fixed member) disposed inside the zoom operation ring 103. Reference numeral 311 denotes a rotation member rotatable relative to the fixed barrel 301. Reference numeral 312 denotes a torsion spring attached to the rotation member 311. Reference numeral 313 denotes a first buffer member (first elastic member) made of a rubber material and attached to the rotation member 311. Reference numeral 314 denotes a retaining member that prevents the first buffer member from coming off the rotation member 311. Reference numeral 315 denotes a screw that fixes the retaining member 314 to the rotation member 311. Reference numeral 323 denotes a second buffer member (second elastic member) made of a rubber material and attached to the zoom operation ring 103.

Reference numeral 103h denotes a first rotation slider that rotationally slides between the zoom operation ring 103 and the fixed barrel 301. Reference numeral 103i denotes a second rotation slider that rotationally slides between the zoom operation ring 103 and the exterior ring 104. Reference numeral 104e denotes an exterior-ring rotation slider that rotationally slides between the zoom operation ring 103 and the exterior ring 104. Reference numeral 301b denotes a fixed-barrel rotation slider that rotationally slides between the zoom operation ring 103 and the fixed barrel 301. Reference numeral 301a denotes a bayonet groove provided in the fixed barrel 301 to restrict the position of the zoom operation ring 103 in the optical axis direction. Thus, the rotation member 311 is engaged with the zoom operation ring 103 via the first buffer member 313, the torsion spring 312, and the second buffer member 323. The zoom operation ring 103 is rotatable relative to the fixed barrel 301 and the exterior ring 104. The rotation member 311 is rotatable relative to the fixed barrel 301.

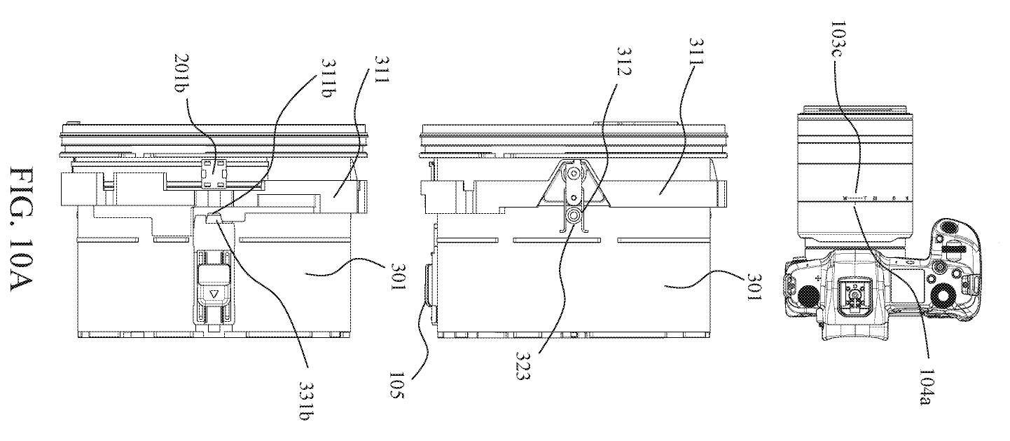

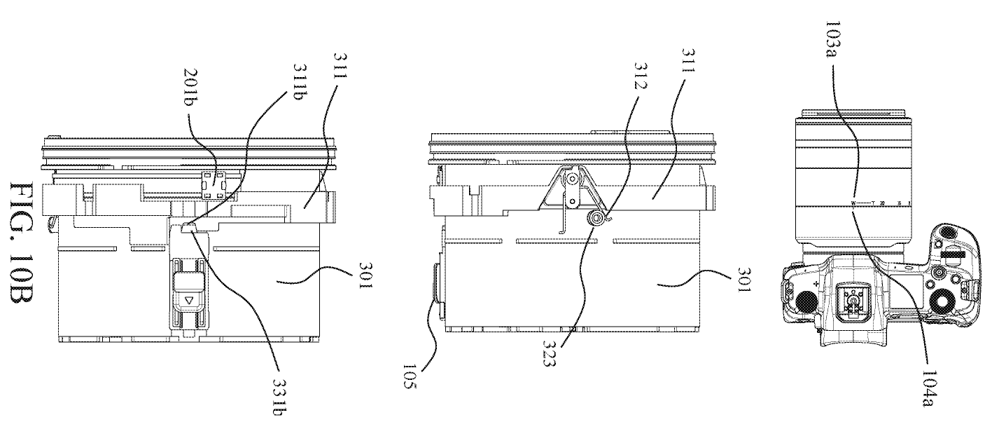

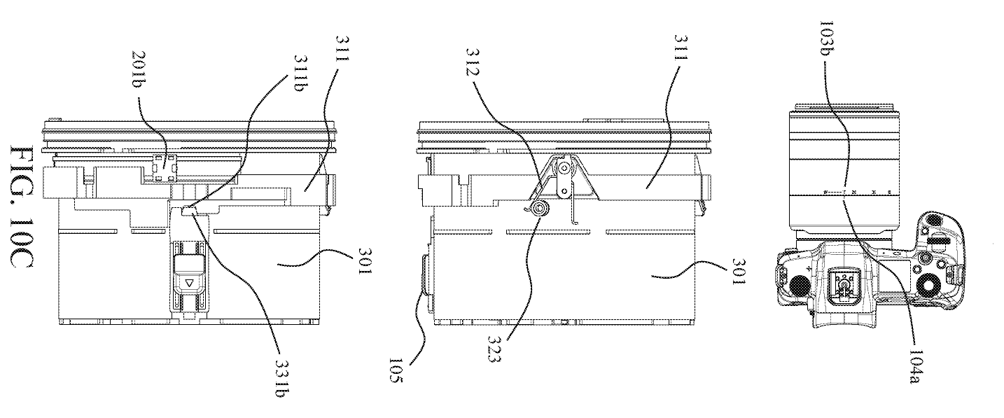

FIGS. 8A and 8B are exploded perspective views of the zoom operation ring unit, and FIGS. 8A and 8B illustrate views viewed from mutually opposite directions. FIGS. 8C and 8D are perspective views of a switching member 331. FIG. 8C illustrates a detailed view of region B in FIG. 8A, and FIG. 8D illustrates a detailed view of region C in FIG. 8A.

Reference numeral 331 denotes the switching member that fixes or releases the rotation member 311. In a state in which the rotation member 311 is fixed by the switching member 331 and no operation force is applied to the zoom operation ring 103, the zoom operation ring 103 moves to a neutral position.

The following elements are provided on the switching member 331. Reference numeral 331a denotes an MZ WIDE mechanical end. Reference numeral 331b denotes a protruding portion. Reference numeral 331c denotes a PZ switching neutral end (second neutral end). The PZ switching neutral end 331c contacts a PZ switching neutral end 311c of the rotation member 311 described below. Reference numeral 331d denotes a restricting portion. Reference numeral 331e denotes a biasing portion. Reference numeral 332 denotes a compression spring that biases the switching member 331 toward the rotation member 311. Reference numeral 333 denotes a screw that fixes the switching operation unit 105 and the switching member 331. Reference numeral 201a denotes a fixed portion of a resistive arc-shaped sensor constituting the zoom detector 201 that detects an angle of the zoom operation ring 103. Reference numeral 201b denotes a movable unit of the resistive arc-shaped sensor constituting the zoom detector 201.

The following elements are provided on the rotation member 311. Reference numeral 311a denotes a PZ TELE mechanical end. Reference numeral 311b denotes a recess. Reference numeral 311c denotes a PZ switching neutral end (first neutral end). The PZ switching neutral end 311c contacts the switching member 331 in the circumferential direction at a neutral position during a switching operation. Reference numeral 311d denotes a relief portion.

The following elements are provided on the zoom operation ring 103. Reference numeral 103g denotes a bayonet convex. Reference numeral 103j denotes a zoom detection engagement portion. Reference numeral 103k denotes a first end (PZ WIDE mechanical end). Reference numeral 103l denotes a second end (PZ TELE mechanical end). Reference numeral 103m denotes a third end (MZ WIDE mechanical end). Reference numeral 103n denotes a fourth end (MZ TELE mechanical end).

The following elements are provided on the exterior ring 104. Reference numeral 104b denotes a switching-member accommodating portion. Reference numeral 104c denotes a perforation hole. Reference numeral 104d denotes a restricting portion. Reference numeral 104f denotes a PZ WIDE mechanical end. Reference numeral 104g denotes an MZ TELE mechanical end.

Next, a relationship between the switching member 331 and the exterior ring 104 will be described. The switching member 331 is accommodated in the switching-member accommodating portion 104b, and the switching operation unit 105 passes through the perforation hole 104c and is fixed to the switching member 331 by the screw 333. The compression spring 332 is disposed between the switching member 331 and the exterior ring 104, and biases the switching member 331 toward the rotation member 311. In a state in which the user does not operate the switching operation unit 105, the restricting portion 331d and the restricting portion 104d contact each other, thereby positioning the switching member 331 and the switching operation unit 105 in the optical axis direction. The biasing portion 331e contacts an inner portion of the exterior ring 104 to bias the switching member 331 toward the optical axis center, thereby positioning the switching member 331 and the switching operation unit 105 in the radial direction. By biasing the switching operation unit 105 toward the optical axis center in this manner, adhesion between the switching operation unit 105 and the exterior ring 104 is improved, and the switching operation unit 105 covers the perforation hole 104c, thereby improving drip-proof performance. The outer shapes of the switching-member accommodating portion 104b and the switching member 331 position the switching member 331 and the switching operation unit 105 also in the circumferential direction. The switching member 331 may be engaged with an unillustrated position detection member. A switching state or a switched state may be detected according to the position of the switching member 331.

Next, a relationship between the switching member 331 and the rotation member 311 will be described. As described above, the rotation member 311 is engaged with the zoom operation ring 103 via the first buffer member 313, the torsion spring 312, and the second buffer member 323. Thus, the rotation angle of the rotation member 311 can follow the rotation angle of the zoom operation ring 103. In a case where the PZ neutral position 103c is aligned with the indicator line 104a, the concave portion 311b and the convex portion 331b are positioned to face each other. When the compression spring 332 biases the switching member 331 toward the rotation member 311, the concave portion 311b and the convex portion 331b are engaged with each other. Thereby, the rotation member 311 is fixed relative to the switching member 331. The PZ switching neutral end 311c and the PZ switching neutral end 331c contact each other in a case where the PZ neutral position 103c is aligned with the indicator line 104a. Thereby, the user can recognize, by tactile feedback at the end, how far the zoom operation ring 103 is to be rotated when switching from the MZ operation to the PZ operation.

In a case where the MZ WIDE focal length index 103d is aligned with the indicator line 104a, the relief portion 311d and the convex portion 331b are positioned to face each other. While the compression spring 332 biases the switching member 331 toward the rotation member 311, the optical-axis-direction position of the switching member 331 is restricted by the restricting portion 331d. In this state, the relief portion 311d and the convex portion 331b are not engaged with each other. Thereby, the rotation member 311 is released relative to the switching member 331.

Next, relationships among the four ends of the zoom operation ring 103, the rotation member 311, the switching member 331, and the exterior ring 104 will be described. The following description relates to a case in which the user operates the zoom operation ring 103. The first end (PZ WIDE mechanical end) 103k contacts the PZ WIDE mechanical end 104f, thereby allowing the user to recognize the PZ WIDE mechanical end. The second end (PZ TELE mechanical end) 103l contacts the PZ TELE mechanical end 311a, thereby allowing the user to recognize the PZ TELE mechanical end. The third end (MZ WIDE mechanical end) 103m contacts the MZ WIDE mechanical end 331a, thereby allowing the user to recognize the MZ WIDE mechanical end. The fourth end (MZ TELE mechanical end) 103n contacts the MZ TELE mechanical end 104g, thereby allowing the user to recognize the MZ TELE mechanical end. As illustrated in FIGS. 8A and 8B, the concave portion 311b and the convex portion 331b may have inclined shapes.

Thereby, when the user rotates the zoom operation ring 103 with a force equal to or smaller than a desired force, the user feels an end, and the MZ operation region and the PZ operation region are separated. When the user rotates the zoom operation ring 103 with a force greater than the desired force, the convex portion 331b rides over the concave portion 311b. As a result, switching between the MZ operation region and the PZ operation region may be performed without user operation of the switching operation unit 105.

In this embodiment, when the zoom operation ring 103 is rotationally operated from the first operation region to the second operation region with a force smaller than a predetermined force, a region dividing end (for example, the second end or the third end) prevents movement from the first operation region to the second operation region. On the other hand, when the zoom operation ring 103 is rotationally operated from the first operation region to the second operation region with a force greater than the predetermined force, the region dividing end retreats, allowing movement from the first operation region to the second operation region. In a case where the zoom operation ring 103 is rotationally operated from the second operation region to the first operation region with a force smaller than the predetermined force, the region dividing end prevents movement from the second operation region to the first operation region. On the other hand, in a case where the zoom operation ring 103 is rotationally operated from the second operation region to the first operation region with a force greater than the predetermined force, the region dividing end retreats, allowing movement from the second operation region to the first operation region.

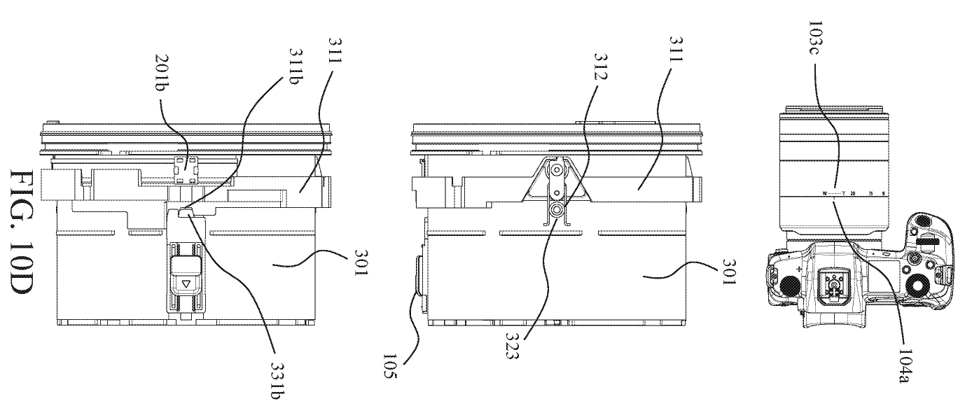

Next, a relationship among the MZ WIDE mechanical end 331a, the convex portion 331b, the concave portion 311b, and the third end (MZ WIDE mechanical end) 103m will be described. The convex portion 331b is a first portion that holds the rotation member 311. The MZ WIDE mechanical end 331a is a second portion that contacts the third end or the fourth end. As illustrated in FIGS. 9A and 9B, the MZ WIDE mechanical end 331a and the convex portion 331b do not overlap each other in the radial direction. The concave portion 311b and the third end (MZ WIDE mechanical end) 103m do not overlap each other in the radial direction.

With such an arrangement, interference among the respective shapes may be avoided when switching operation is performed by rotating the zoom operation ring 103 from the MZ operation region to the PZ operation region or from the PZ operation region to the MZ operation region, thereby achieving a zoom operation ring 103 capable of operation switching.

Next, a relationship between the zoom detection engagement portion 103j and the zoom detection movable unit 201b will be described. The zoom detection engagement portion 103j and the zoom detection movable unit 201b are engaged with each other. Thus, the rotation angle of the zoom operation ring 103 operated by the user may be detected. As illustrated in FIG. 8B, a detection region of a single angle detection sensor (zoom detector 201) may be disposed and provided so as to include both the PZ operation region and the MZ operation region. This provides an effect of reducing the number of sensors compared with a case in which different angle detection sensors are arranged and provided separately for the PZ operation region and the MZ operation region.

In this embodiment, the zoom detector 201 is a single detector that detects whether the zoom operation ring 103 is disposed in the first operation region or the second operation region. Alternatively, the zoom detector 201 may include a first detector that detects that the zoom operation ring 103 is disposed in the first operation region and a second detector that detects that the zoom operation ring 103 is disposed in the second operation region.

Next, the placement of the torsion spring 312 will be described. As illustrated in FIG. 8B, two or more torsion springs 312 may be arranged and engaged with the zoom operation ring 103. This allows a spring force per torsion spring to be reduced compared with a case in which a single torsion spring is used. Thus, the torsion springs may be designed to be smaller, and an effect of reducing an outer diameter of the lens apparatus 101 may be achieved.

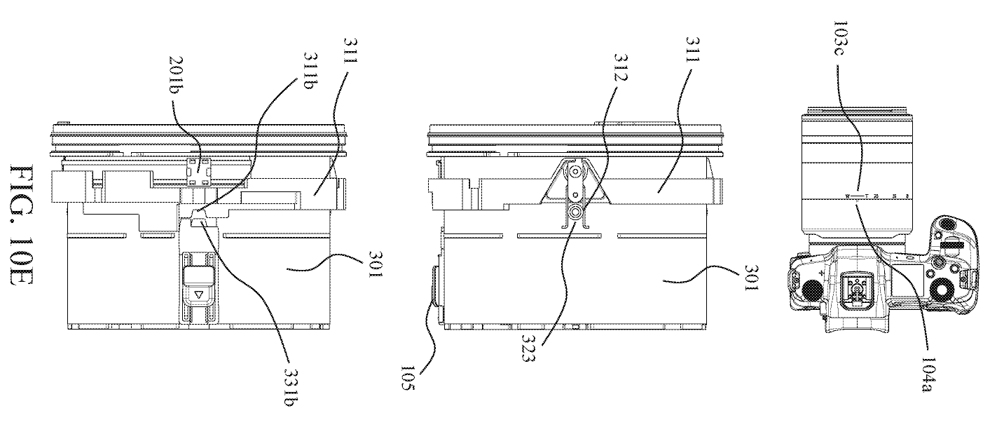

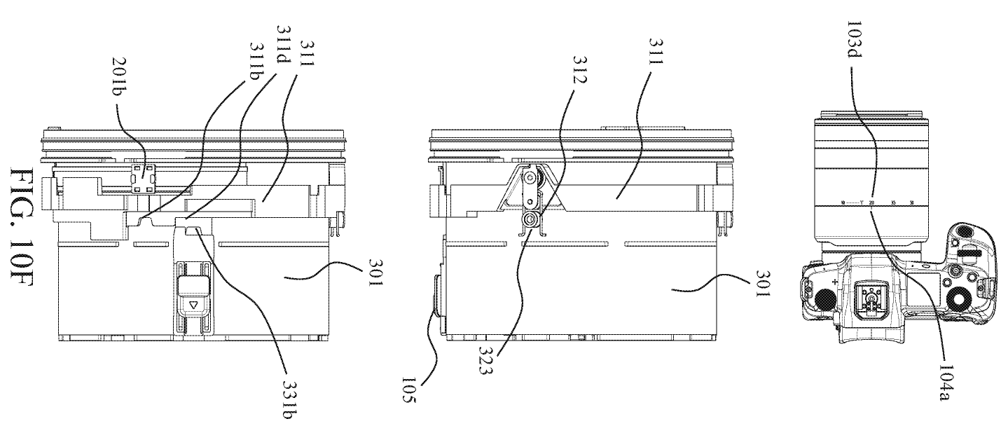

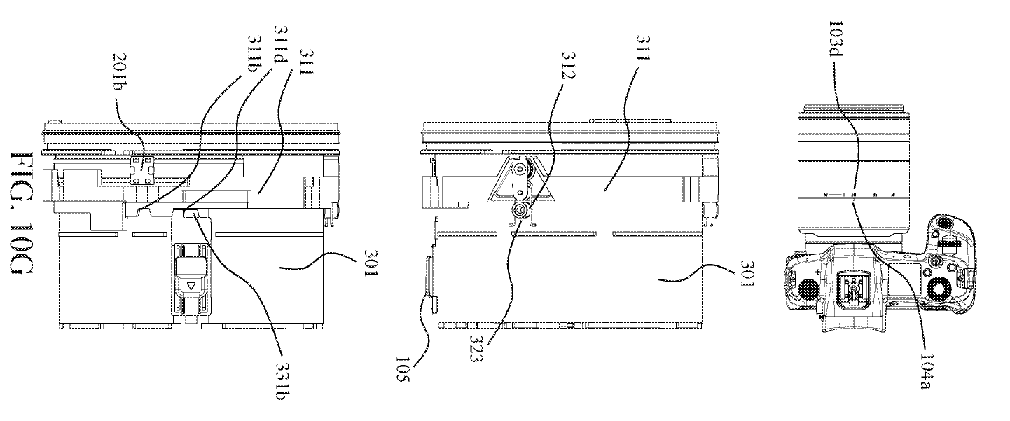

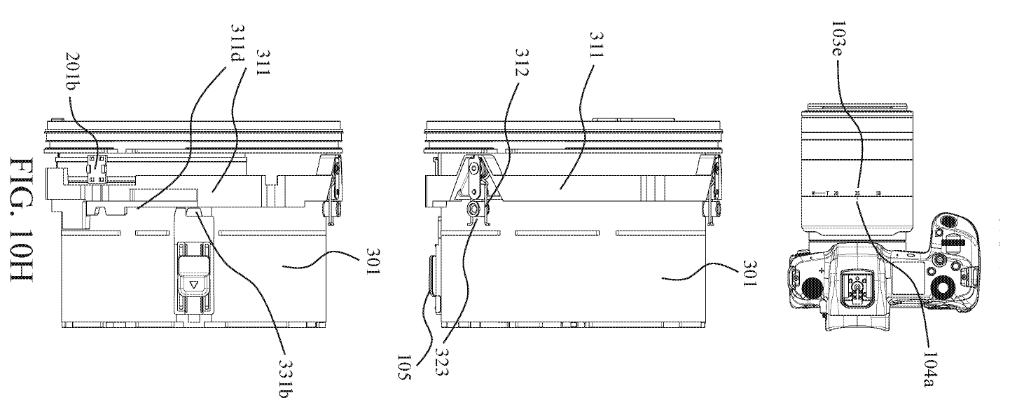

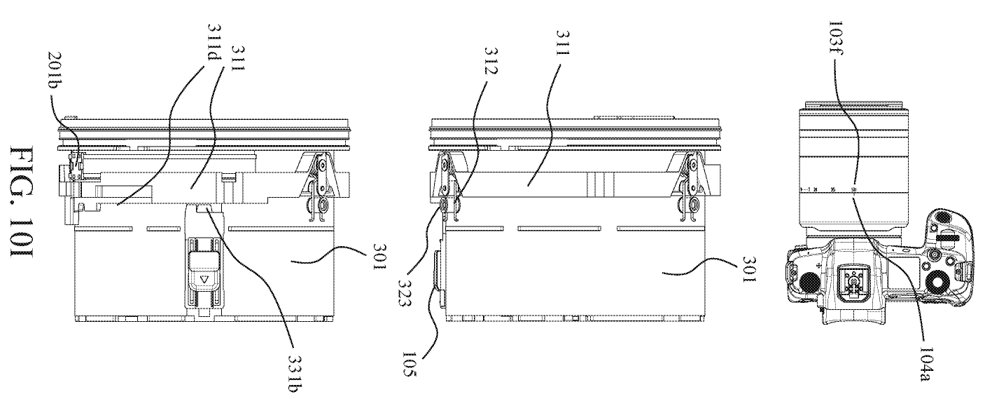

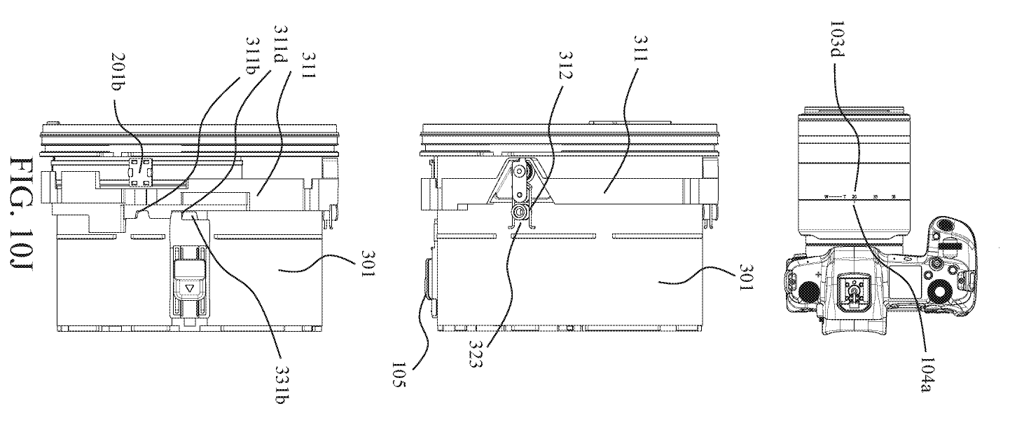

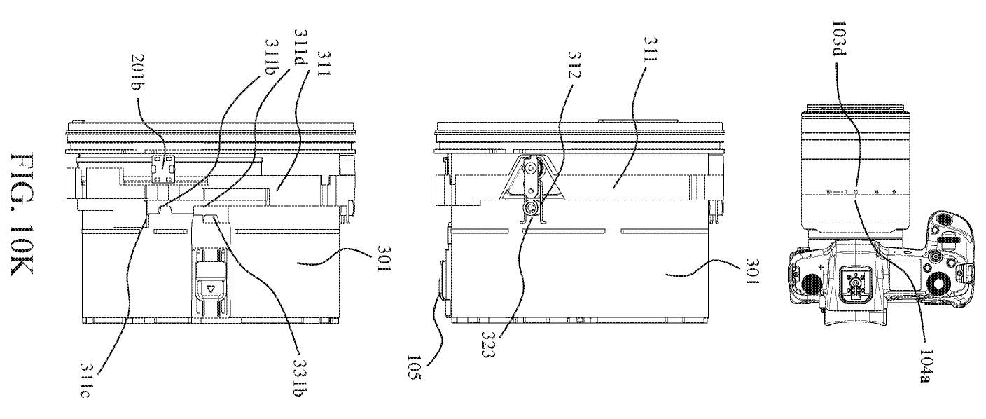

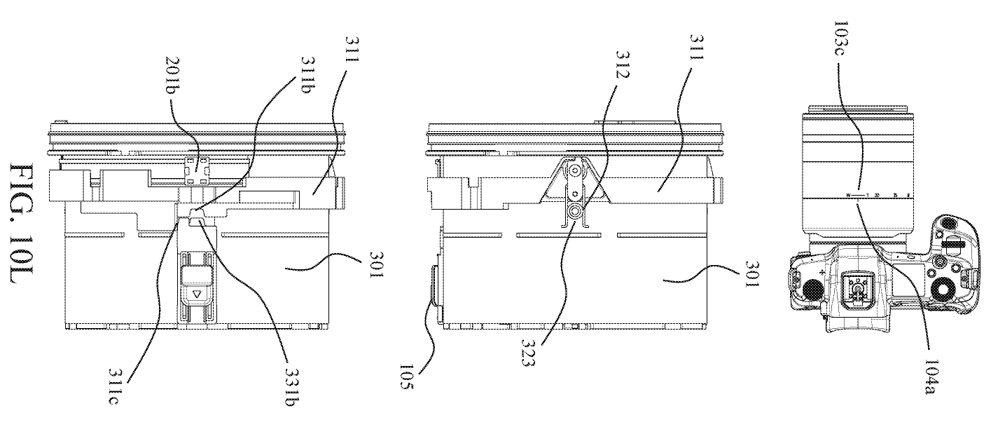

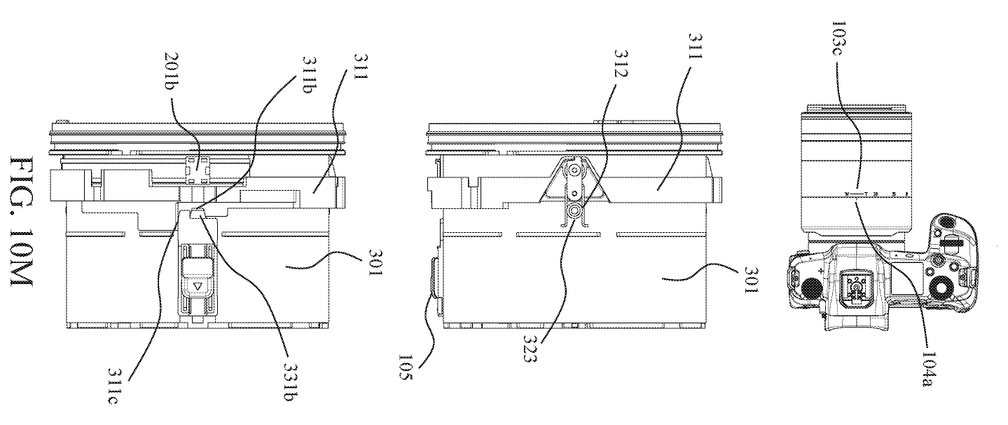

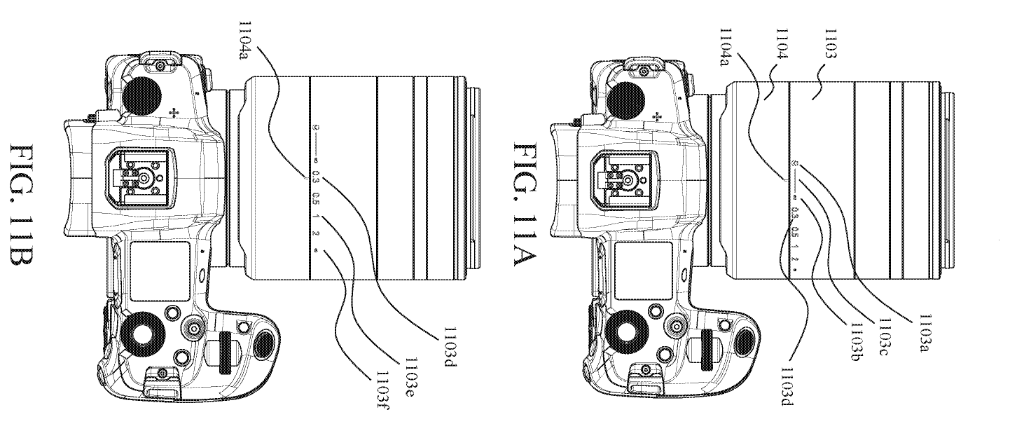

Next, with reference to FIGS. 10A to 10M, a description will be given of the internal structure according to the rotation angle of the zoom operation ring 103 and the state of the switching operation unit 105. FIGS. 10A to 10M illustrate the internal state of the zoom operation ring unit.

A description will now be given of switching operation from PZ operation to MZ operation with reference to FIGS. 10A to 10I. FIG. 10A illustrates a neutral position state in the PZ operation. As illustrated in FIG. 10A, the convex portion 331b is engaged with the concave portion 311b, and the rotation member 311 is fixed to the switching member 331. A torsion spring 312 is engaged with the first buffer member 313 and the second buffer member 323.

FIG. 10B illustrates a state during operation in the WIDE direction in the PZ operation. As illustrated in FIG. 10B, the convex portion 331b is engaged with the concave portion 311b to fix the rotation member 311 to the switching member 331. One end of the torsion spring 312 is engaged with the second buffer member 323, and the other end of the torsion spring 312 is engaged with the first buffer member 313. Thus, the zoom operation ring 103 receives a force from the torsion spring 312 toward the neutral position.

FIG. 10C illustrates a state during operation in the TELE direction in the PZ operation. As illustrated in FIG. 10C, the convex portion 331b is engaged with the concave portion 311b to fix the rotation member 311 to the switching member 331. The other end of the torsion spring 312 is engaged with the second buffer member 323, and one end of the torsion spring 312 is engaged with the first buffer member 313. Thus, the zoom operation ring 103 receives a force from the torsion spring 312 toward the neutral position.

FIG. 10D illustrates a state after the user releases the zoom operation ring 103 following the operation in the WIDE or TELE direction in the PZ operation. As illustrated in FIG. 10D, the convex portion 331b is engaged with the concave portion 311b to fix the rotation member 311 to the switching member 331. The torsion spring 312 is engaged with the first buffer member 313 and the second buffer member 323. One end or the other end of the torsion spring 312 operates so as to come into contact with the first buffer member 313 or the second buffer member 323 after being separated from the first buffer member 313 or the second buffer member 323. Since the first buffer member 313 and the second buffer member 323 are made of a rubber material, an effect of reducing contact noise with the torsion spring 312 is obtained. This also provides an effect of reducing the intrusion of the operation noise of the zoom operation ring 103 into the recorded sound of a moving image.

FIG. 10E illustrates a state during a switching operation from the PZ operation region to the MZ operation region. As illustrated in FIG. 10E, the convex portion 331b is separated from the concave portion 311b, thereby releasing the rotation member 311 from the switching member 331. At this time, the zoom operation ring 103 may rotate in a direction in which the MZ operation region indicator is aligned with the indicator line 104a.

FIG. 10F illustrates a state immediately before the switching operation, in which the MZ WIDE focus indicator is aligned with the indicator line 104a. As illustrated in FIG. 10F, the convex portion 331b is separated from the relief portion 311d, and the rotation member 311 is still released from the switching member 331. At this time, the relief portion 311d and the convex portion 331b face each other, and the switching member 331 is in a state in which it may move toward the rotation member 311.

FIG. 10G illustrates a state in which the user releases the switching operation unit 105 with the MZ WIDE focus indicator aligned with the indicator line 104a. As illustrated in FIG. 10G, the convex portion 331b is separated from the relief portion 311d, and the rotation member 311 is released from the switching member 331. Thus, the zoom operation ring 103 may rotate within the MZ operation region.

FIG. 10H illustrates a state in which the MZ MIDDLE focus indicator is aligned with the indicator line 104a and the user releases the switching operation unit 105. As illustrated in FIG. 10H, the convex portion 331b is separated from the relief portion 311d, and the rotation member 311 is released from the switching member 331. Thus, the zoom operation ring 103 may rotate within the MZ operation region.

FIG. 10I illustrates a state in which the MZ TELE focus indicator is aligned with the indicator line 104a and the user releases the switching operation unit 105. As illustrated in FIG. 10I, the convex portion 331b is separated from the relief portion 311d, and the rotation member 311 is released from the switching member 331. Thus, the zoom operation ring 103 may rotate within the MZ operation region.

Next, switching operation from MZ operation to PZ operation will be described with reference to FIGS. 10J, 10K, 10L, and 10M. . FIG. 10J illustrates a state in which the MZ WIDE focus indicator is aligned with the indicator line 104a. As illustrated in FIG. 10J, the convex portion 331b is separated from the concave portion 311b, and the rotation member 311 is released from the switching member 331. At this time, the MZ WIDE mechanical end 331a and the third end (MZ WIDE mechanical end) 103m are in contact with each other. Thus, the zoom operation ring 103 is restricted from rotating in a direction in which the PZ neutral position 103c is aligned with the indicator line 104a.

FIG. 10K illustrates a state in which the MZ WIDE focus indicator is aligned with the indicator line 104a. As illustrated in FIG. 10K, the convex portion 331b is moved in a direction away from the rotation member 311. Thus, the rotation member 311 is in a state in which it can rotate relative to the switching member 331.

FIG. 10L illustrates a state just before the switching operation, in which the PZ neutral position 103c is aligned with the indicator line 104a. As illustrated in FIG. 10L, the convex portion 331b is separated from the concave portion 311b, and the rotation member 311 is still released from the switching member 331. At this time, the concave portion 311b and the convex portion 331b face each other, and the switching member 331 is in a state in which it can move toward the rotation member 311. In addition, the PZ switching neutral end 311c and the PZ switching neutral end 331c come into contact with each other. Thereby, switching from the MZ operation to the PZ operation can suggest to the user, by the tactile feel of the end contact, how far the zoom operation ring 103 is to be rotated, thereby providing an effect of improving the switching operation.

FIG. 10M illustrates a state in which the user rotates the zoom operation ring 103 from the Z operation region to the PZ operation region and releases the switching operation unit 105. As illustrated in FIG. 10M, the convex portion 331b is engaged with the concave portion 311b to fix the rotation member 311 to the switching member 331. The torsion spring 312 is engaged with the first buffer member 313 and the second buffer member 323.

Providing the operation member according to this embodiment can provide an optical apparatus that has a reduced overall length.

### SECOND EMBODIMENT

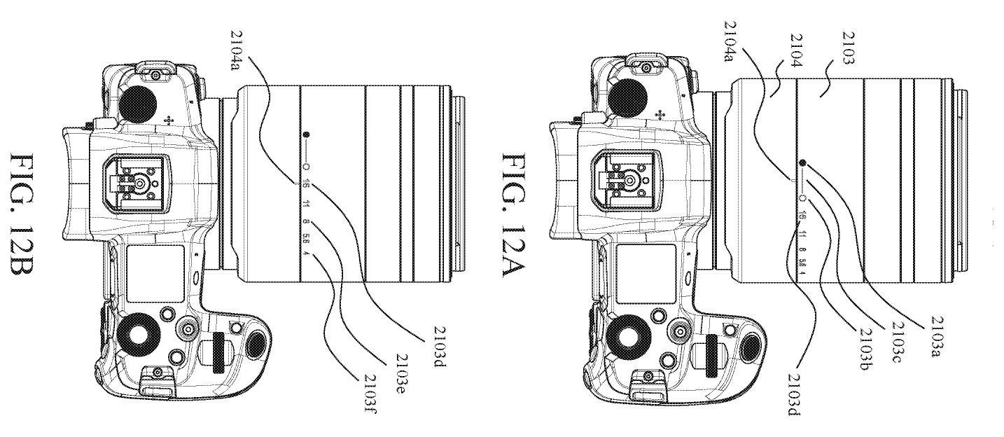

Next, a second embodiment of the present disclosure will be described with reference to FIGS. 11A and 11B. FIGS. 11A and 11B illustrate indicators of a focus operation ring (focus operation member) 1103 according to this embodiment. FIG. 11A illustrates power focus (PF) operation indicators arranged in a first operation region. FIG. 11B illustrates manual focus (MF) operation indicators arranged in a second operation region. Hereinafter, power focus will be referred to as PF, and manual focus will be referred to as MF.

As illustrated in FIG. 11A, the focus operation ring 1103 displays a PF close-distance-direction indicator 1103a, a PF infinity-direction indicator 1103b, and a PF neutral position 1103c. Using these indicators, the user can instruct the lens apparatus 101 to move a focus lens position relatively in the close-distance direction or the infinity direction (relative position control). The user may instruct the lens apparatus 101 to stop lens movement using the PF neutral position 1103c. As illustrated in FIG. 11B, the focus operation ring 1103 displays an MF close-distance indicator 1103d, an MF intermediate-distance indicator 1103e, and an MF infinity-distance indicator 1103f. Using these indicators, the user may instruct the lens apparatus 101 to set the focus lens position by an absolute value (absolute position control).

During PF operation, the user can feel a first end at which rotation is restricted at the position of the PF close-distance-direction indicator 1103a, and a second end at which rotation is restricted at the position of the PF infinity-direction indicator 1103b. During PF operation, a neutral-position return force that urges the focus operation ring 1103 to return to the neutral position 1103c is applied to the focus operation ring 1103. Thereby, while the user releases the focus operation ring 1103 and no operating force is applied thereto, the focus operation ring 1103 moves to the neutral position 1103c. During MF operation, the user can feel a third end at which rotation is restricted at the position of the MF close-distance indicator 1103d, and a fourth end at which rotation is restricted at the position of the MF infinity-distance indicator 1103f. Thereby, the user can sense the close-distance or infinity position by the tactile feel of the ends without visually checking the indicators, thereby enabling image capturing. Since the internal mechanism is the same as that of the first embodiment, a description thereof will be omitted.

### THIRD EMBODIMENT

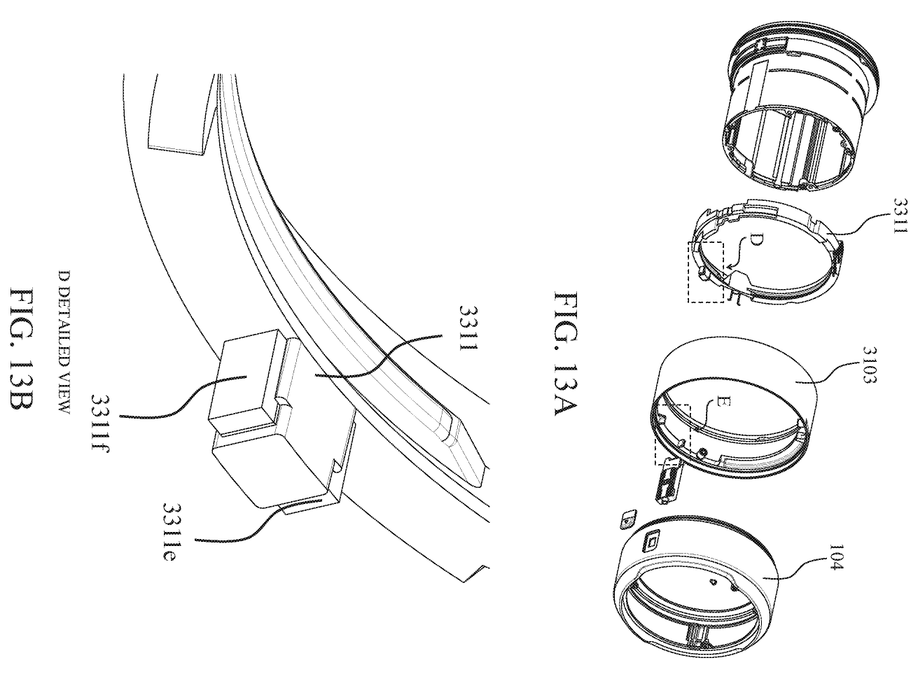

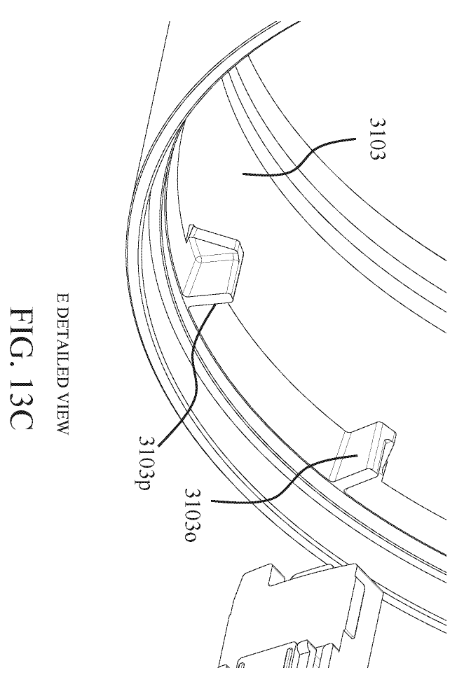

Next, a third embodiment of the present disclosure will be described with reference to FIGS. 12A and 12B. FIGS. 12A and 12B illustrate indicators of an iris operation ring (aperture operation member for adjusting an aperture value) 2103 according to this embodiment. FIG. 12A illustrates power iris (PI) operation indicators arranged in a first operation region. FIG. 12B illustrates manual iris (MI) operation indicators arranged in a second operation region. Hereinafter, power iris will be referred to as PI, and manual iris will be referred to as MI.

As illustrated in FIG. 12A, the iris operation ring 2103 displays a PI aperture-closing-direction indicator 2103a, a PI aperture-opening-direction indicator 2103b, and a PI neutral position 2103c. Using these indicators, the user may instruct the lens apparatus 101 to move an aperture blade member or an aperture rotating member relatively in the aperture-closing direction or the aperture-opening direction (relative position control). The user may instruct the lens apparatus 101 to stop movement of the aperture blade member or the aperture rotating member using the PI neutral position 2103c.

As illustrated in FIG. 12B, the iris operation ring 2103 displays an MI maximum F-number indicator 2103d, an MI intermediate F-number indicator 2103e, and an MI minimum F-number indicator 2103f. Using these indicators, the user may instruct the lens apparatus 101 to set the position of the aperture blade member or the aperture rotating member by an absolute value (absolute position control).

During PI operation, the user can feel a first end at which rotation is restricted at the position of the PI aperture-closing-direction indicator 2103a, and a second end at which rotation is restricted at the position of the PI aperture-opening-direction indicator 2103b. During PI operation, a neutral-position return force that urges the iris operation ring 2103 to return to the neutral position 2103c is applied to the iris operation ring 2103. Thereby, while the user releases the iris operation ring 2103 and no operating force is applied thereto, the iris operation ring 2103 moves to the neutral position 2103c.

During MI operation, the user can feel a third end at which rotation is restricted at the position of the MI maximum F-number indicator 2103d, and a fourth end at which rotation is restricted at the position of the MI minimum F-number indicator 2103f. Thereby, the user may sense the maximum F-number or the minimum F-number by the tactile feel of the ends without visually checking the indicators, thereby enabling image capturing. Since the internal mechanism is the same as that of the first embodiment, a description thereof will be omitted.

The configurations according to this embodiment and the respective members are not limited to those described above, and various configurations may be used as long as the functions are satisfied. For example, the zoom detector 201 may be a magnetic sensor instead of a resistive arc-type sensor. The zoom detector 201 may be a sensor that performs turning-on/off detection to detect positions through which the zoom operation ring 103 passes, instead of a sensor that outputs a detected angle as an absolute value. In that case, the resolution of angle detection of the zoom operation ring 103 may be reduced; however, compared with an arc-type sensor, the turning-on/off detection sensor may enable a product to be configured at lower cost.

### FOURTH EMBODIMENT

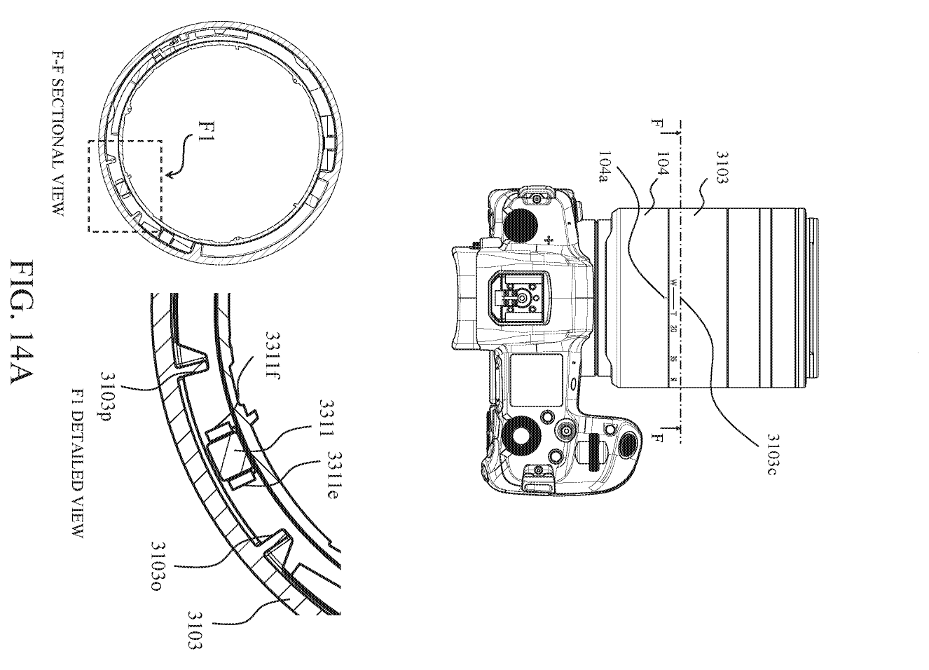

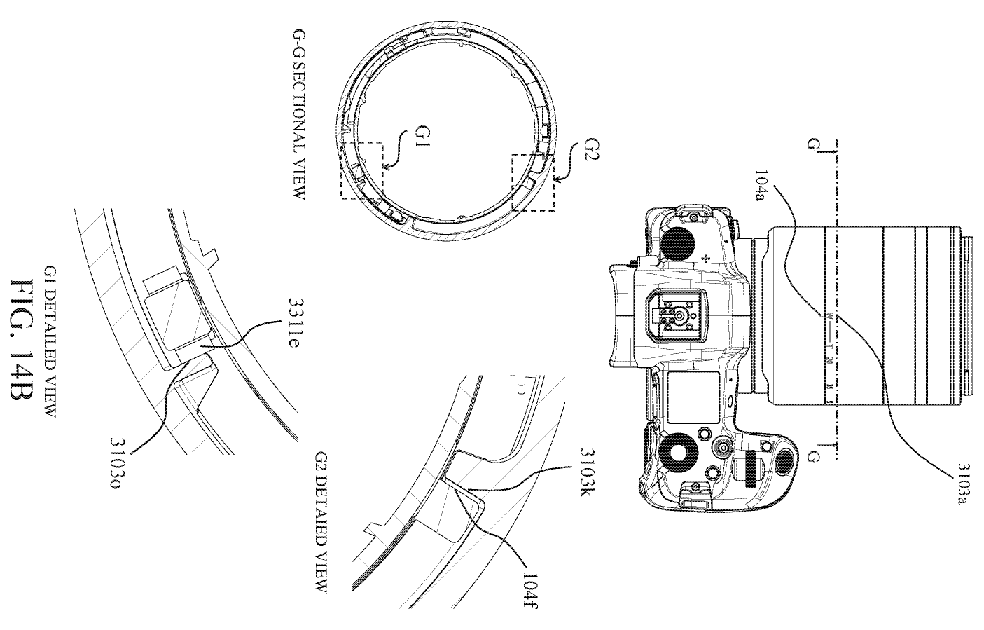

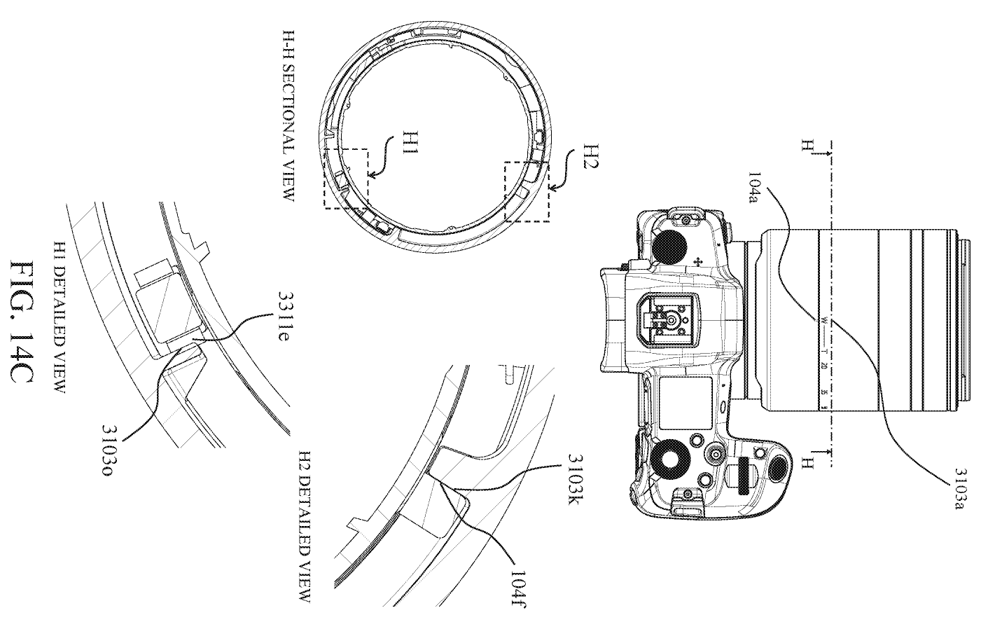

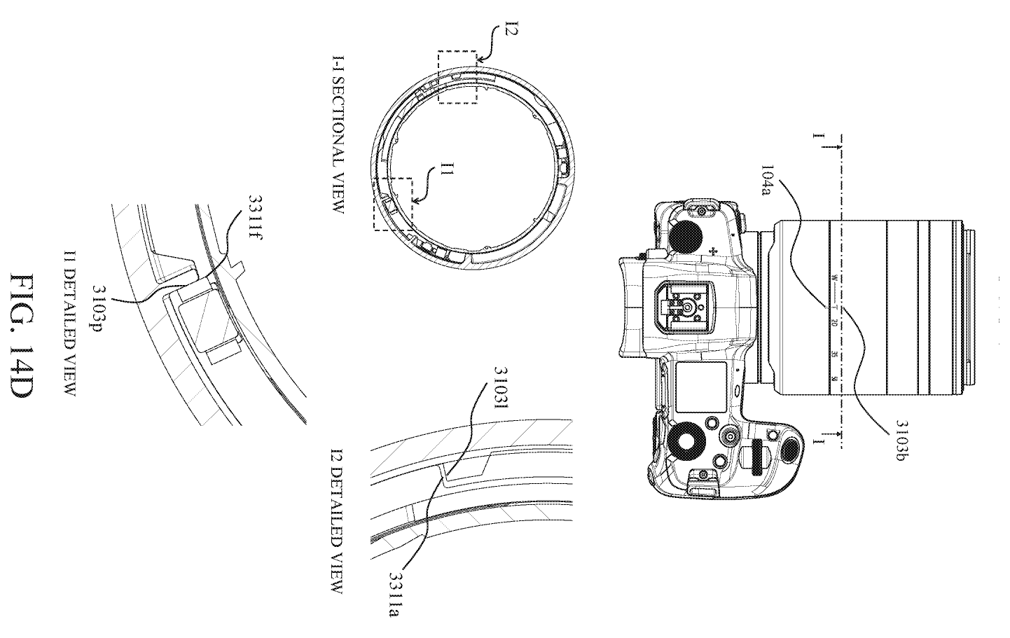

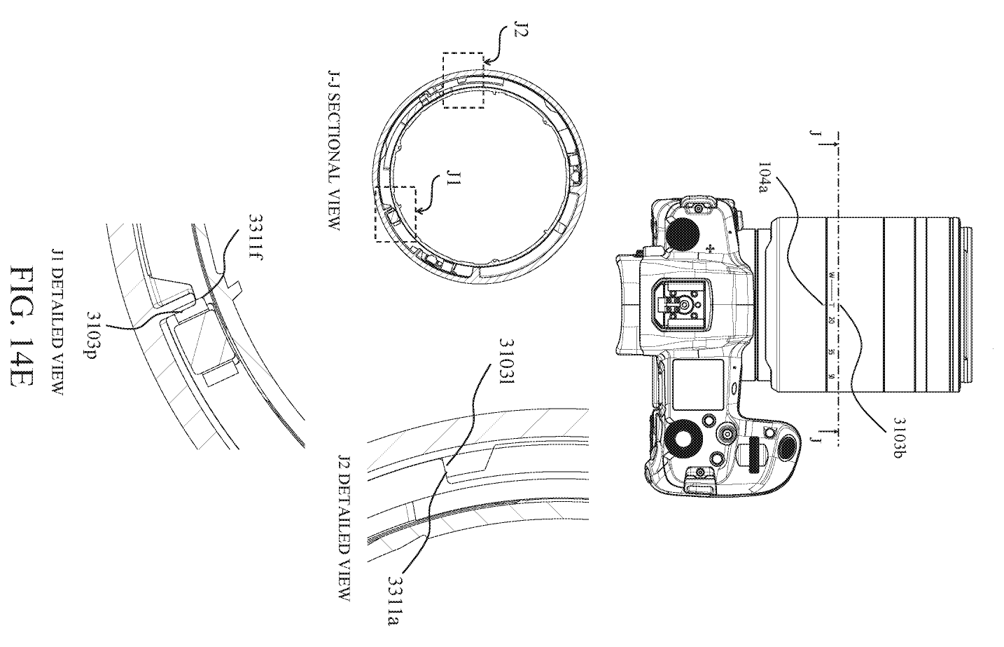

Next, a fourth embodiment of the present disclosure will be described with reference to FIGS. 13A to 14E.

FIG. 13A is an exploded perspective view of a zoom operation ring unit. FIG. 13B is a detailed view of region D in FIG. 13A. FIG. 13C is a detailed view of region E in FIG. 13A. This embodiment will discuss configurations different from those of the first embodiment, and will omit a description common to that of the first embodiment.

The zoom operation ring unit according to this embodiment includes a rotation member 3311. The rotation member 3311 includes a first damping member 3311e and a second damping member 3311f. The first damping member 3311e and the second damping member 3311f are fixed to the rotation member 3311 by double-sided tape or adhesive. The first damping member 3311e and the second damping member 3311f are made of a urethane material or a rubber material, and also function as third elastic members.

The zoom operation ring unit according to this embodiment includes a zoom operation ring (operation member) 3103. The zoom operation ring 3103 includes a first damping member contact end (first damping member contact portion) 3103o and a second damping member contact end (second damping member contact portion) 3103p. The first damping member contact end 3103o and the second damping member contact end 3103p extend from the zoom operation ring 3103.

FIG. 14A illustrates the interior of the zoom operation ring unit when the zoom operation ring 3103 is located at a PZ neutral position. As illustrated in FIG. 14A, in a case where the PZ neutral position 3103c of the zoom operation ring 3103 is aligned with the indicator line 104a, the first damping member 3311e does not contact the first damping member contact end 3103o, and the second damping member 3311f does not contact the second damping member contact end 3103p. During MZ operation as in the first embodiment, the first damping member 3311e does not contact the first damping member contact end 3103o, and the second damping member 3311f does not contact the second damping member contact end 3103p.

FIG. 14B illustrates the interior of the zoom operation ring unit just before the zoom operation ring 3103 contacts a PZ WIDE mechanical end. The zoom operation ring 3103 includes a PZ WIDE direction indicator 3103a. The zoom operation ring 3103 includes a first mechanical end (PZ WIDE mechanical end) 3103k. The exterior ring 104 includes a PZ WIDE mechanical end 104f. As illustrated in FIG. 14B, just before the first mechanical end (PZ WIDE mechanical end) 3103k contacts the PZ WIDE mechanical end 104f, the first damping member 3311e contacts the first damping member contact end 3103o.

FIG. 14C illustrates the interior of the zoom operation ring unit when the zoom operation ring 3103 contacts the PZ WIDE mechanical end. As illustrated in FIG. 14C, in a case where the first mechanical end (PZ WIDE mechanical end) 3103k contacts the PZ WIDE mechanical end 104f, the first damping member 3311e contacts the first damping member contact end 3103o, and the first damping member 3311e is compressed. Thereby, it is possible to attenuate a collision force between the first mechanical end (PZ WIDE mechanical end) 3103k and the PZ WIDE mechanical end 104f during operation of the zoom operation ring 3103, thereby reducing mechanical end collision noise during PZ operation. Since PZ operation is often used during moving image capturing, it is possible to suppress sound recording of mechanical end collision noise in a moving image. In addition, placing the first damping member 3311e and the first damping member contact end 3103o between the zoom operation ring 3103 and the rotation member 3311 can improve space efficiency. Thereby, the size of the optical apparatus can be reduced.

FIG. 14D illustrates the interior of the zoom operation ring unit just before the zoom operation ring 3103 contacts a PZ TELE mechanical end. The zoom operation ring 3103 includes a PZ TELE direction indicator 3103b. The zoom operation ring 3103 includes a second mechanical end (PZ TELE mechanical end) 3103l. The rotation member 3311 includes a PZ TELE mechanical end 3311a. As illustrated in FIG. 14D, just before the second mechanical end (PZ TELE mechanical end) 3103l contacts the PZ TELE mechanical end 3311a, the second damping member 3311f contacts the second damping member contact end 3103p.

FIG. 14E illustrates the interior of the zoom operation ring unit when the zoom operation ring 3103 contacts the PZ TELE mechanical end. As illustrated in FIG. 14E, in a case where the second mechanical end (PZ TELE mechanical end) 3103l contacts the PZ TELE mechanical end 3311a, the second damping member 3311f contacts the second damping member contact end 3103p, and the second damping member 3311f is compressed. Thereby, it is possible to attenuate a collision force between the second mechanical end (PZ TELE mechanical end) 3103l and the PZ TELE mechanical end 3311a during operation of the zoom operation ring 3103, thereby reducing mechanical end collision noise during PZ operation. Since PZ operation is often used for capturing a moving image, it is possible to suppress sound recording of mechanical end collision noise in a moving image. In addition, by placing the second damping member 3311f and the second damping member contact end 3103p between the zoom operation ring 3103 and the rotation member 3311 can improve space efficiency. Thereby, the size of the optical apparatus can be reduced.

The configuration according to this embodiment and each member are not limited to those described above, and various configurations may be used as long as the functions are satisfied. For example, the first damping member 3311e and the second damping member 3311f may be fixed to the rotation member 3311 by an adhesive. Thereby, the product can be configured at lower cost than a case where double-sided tape is used. The first damping member 3311e and the second damping member 3311f may be made of a rubber material. Depending on the material of the first damping member 3311e and the second damping member 3311f, the tactile feel at contact between the first damping member and the first damping member contact end may be changed according to operator preference. The first damping member 3311e and the second damping member 3311f may be disposed on the zoom operation ring 3103, and the first damping member contact end 3103o and the second damping member contact end 3103p may extend from the rotation member 3311. That is, the rotation member 3311 may include one of a damping member or a damping member contact portion, and the operation member may include the other. This example may also be applied to the configuration of the second or third embodiment.

In each embodiment, the lens apparatus 101 includes the switching operation unit 105, but the switching operation unit 105 does not necessarily need to be provided on the lens apparatus 101. The configuration may be adopted in which movement between the first operation region and the second operation region is enabled by a force applied to rotate the zoom operation ring 103 using inclined shapes of the concave portion 311b and the convex portion 331b. When the user rotates the zoom operation ring 103 with a force equal to or less than a predetermined force, the user feels an end, and the MZ operation region and the PZ operation region are separated. When the user rotates the zoom operation ring 103 with a force greater than the predetermined force, the convex portion 331b rides over the concave portion 311b. This configuration can reduce the switching operation unit 105. Alternatively, the concave portion 311b and the convex portion 331b may not be inclined, a surface perpendicular to the rotation direction of the zoom operation ring 103 may be set, and the switching operation unit 105 may be provided. In that case, it becomes difficult for the convex portion 331b to ride over the concave portion 311b merely by rotating the zoom operation ring 103, and it is possible to reduce the possibility of unintended operation switching by the user.

The lens apparatus 101 according to each embodiment includes the first buffer member 313 and the second buffer member 323, but one or both of the first buffer member 313 and the second buffer member 323 may be omitted. This configuration can reduce the number of members, thereby achieving an optical apparatus at lower cost.

Each example can reduce the overall length of an optical apparatus including an operation member in which operation can be switched, and can provide a compact optical apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051747, filed on Mar. 26, 2025, and Japanese Patent Application No. 2025-147385, filed on Sep. 5, 2025, which are hereby incorporated by reference herein in their entirety.

What is claimed is:

1. An optical apparatus comprising:
an operation member that can operate an optical member, and has a first operation region and a second operation region along a circumferential direction of the operation member;
one or more memories storing instructions; and
one or more processors that, upon execution of the instructions, operate to:
control the optical member, according to a rotational operation of the operation member in the circumferential direction, in a control mode selected from a plurality of modes including a first mode and a second mode,
control the optical member in the first mode according to the rotational operation in the first operation region of the operation member, and
control the optical member in the second mode according to the rotational operation in the second operation region of the operation member.

2. The optical apparatus according to claim 1, wherein the one or more processors operate to:
perform relative position control on the optical member according to the rotational operation of the operation member in the first mode, and
perform absolute position control on the optical member according to the rotational operation of the operation member in the second mode.

3. The optical apparatus according to claim 1, wherein the first operation region has a neutral position at which the optical member is not to be moved, and
wherein, in a state in which no operating force is applied to the operation member in the first operation region, the operation member is configured to move to the neutral position.

4. The optical apparatus according to claim 3, further comprising a rotation member having an elastic member, and a switching member,
wherein the operation member is engaged with the rotation member, and
wherein the rotation member is fixed or released by the switching member.

5. The optical apparatus according to claim 4, wherein the rotation member has a first neutral end that contacts the switching member in the circumferential direction at the neutral position during a switching operation.

6. The optical apparatus according to claim 5, wherein the switching member has a second neutral end that contacts the first neutral end.

7. The optical apparatus according to claim 4, wherein, in a state in which the rotation member is fixed by the switching member and no operating force is applied to the operation member, the operation member is configured to move to the neutral position.

8. The optical apparatus according to claim 1, wherein the operation member has a plurality of ends that restrict rotation in the circumferential direction during the rotational operation.

9. The optical apparatus according to claim 8, wherein the plurality of ends include a first end, a second end, a third end, and a fourth end.

10. The optical apparatus according to claim 9, wherein the operation member has the first end and the second end in the first operation region.

11. The optical apparatus according to claim 9, wherein the operation member has the third end and the fourth end in the second operation region.

12. The optical apparatus according to claim 9, further comprising a rotation member having an elastic member, and a switching member,
wherein the operation member is engaged with the rotation member,
wherein the rotation member is fixed or released by the switching member, and
wherein the rotation member has an end that contacts at least one of the first end and the second end.

13. The optical apparatus according to claim 9, further comprising a rotation member having an elastic member, and a switching member,
wherein the operation member is engaged with the rotation member,
wherein the rotation member is fixed or released by the switching member, and
wherein the switching member has a first portion that fixes the rotation member and a second portion that contacts the third end or the fourth end.

14. The optical apparatus according to claim 13, wherein the first portion and the second portion do not overlap each other in a radial direction of the operation member.

15. The optical apparatus according to claim 1, further comprising a rotation member having an elastic member, and a switching member,
wherein the operation member is engaged with the rotation member,
wherein the rotation member is fixed or released by the switching member, and
wherein the switching member has a biasing portion that biases the switching member.

16. The optical apparatus according to claim 15, wherein the elastic member is engaged with the operation member.

17. The optical apparatus according to claim 1, further comprising a detector configured to detect a position of the operation member.

18. The optical apparatus according to claim 17, wherein the detector is a single detector configured to detect whether the operation member is located in the first operation region or the second operation region.

19. The optical apparatus according to claim 17, wherein the detector includes a first detector configured to detect that the operation member is located in the first operation region, and a second detector configured to detect that the operation member is located in the second operation region.

20. The optical apparatus according to claim 1, further comprising a switching operation unit configured to switch between the first mode and the second mode.

21. The optical apparatus according to claim 1, wherein, in a case where the operation member is rotationally operated from the first operation region to the second operation region with a force smaller than a predetermined force, movement from the first operation region to the second operation region is prevented by a region dividing end, and
wherein, in a case where the operation member is rotationally operated from the first operation region to the second operation region with a force greater than the predetermined force, the region dividing end retracts, thereby allowing movement from the first operation region to the second operation region.

22. The optical apparatus according to claim 1, wherein, in a case where the operation member is rotationally operated from the second operation region to the first operation region with a force smaller than a predetermined force, movement from the second operation region to the first operation region is prevented by a region dividing end, and
wherein, in a case where the operation member is rotationally operated from the second operation region to the first operation region with a force greater than the predetermined force, the region dividing end retracts, thereby allowing movement from the second operation region to the first operation region.

23. The optical apparatus according to claim 1, further comprising a rotation member that is engaged with the operation member,
wherein the rotation member has one of a damping member and a damping-member contact portion, and
wherein the operation member has the other of the damping member and the damping-member contact portion.

24. The optical apparatus according to claim 23, wherein the damping member and the damping-member contact portion contact each other in the first operation region.

25. The optical apparatus according to claim 23, wherein the damping member and the damping-member contact portion do not contact each other in the second operation region.

26. The optical apparatus according to claim 23, wherein the damping member is made of urethane or rubber.

27. The optical apparatus according to claim 23, wherein the damping member is fixed to the rotation member by adhesion or double-sided tape.

28. The optical apparatus according to claim 1, wherein the operation member is a zoom operation member for zooming.

29. The optical apparatus according to claim 1, wherein the operation member is a focus operation member for focusing.

30. The optical apparatus according to claim 1, wherein the operation member is an aperture operation member for adjusting an aperture value.

31. The optical apparatus according to claim 1, wherein the optical member includes a lens.

32. The optical apparatus according to claim 30, wherein the optical member includes an aperture stop.
